(19) United States
(12) Patent Application Publication
(10) Pub. No.: US 2006/0194070 A1
(43) Pub. Date: Aug. 31, 2006

(54) Polyetherimide film and multilayer structure

(76) Inventors: Joshua Croll, Latham, NY (US); Irene Dris, Clifton Park, NY (US); Robert R. Gallucci, Mt. Vernon, IN (US); Kapil Chandrakant Sheth, Evansville, IN (US); Guangda Shi, Evansville, IN (US); James White, Schenectady, NY (US)

Correspondence Address: Henry Gibson;General Electric Company, One Plastics Avenue, Pittsfield, MA, 01201, US

(21) Appl. No.: 11/067,268

(22) Filed: Feb. 25, 2005

(51) Int. Cl. B32B 27/00; C08G 73/00

(52) U.S. Cl. 428/473.5; 528/170

(57) ABSTRACT

Various embodiments of a polyetherimide film and multilayer structure are provided. In one embodiment the polyetherimide film has a glass transition temperature that ranges from about 260° C. to about 350° C. and the polyetherimide has a melt viscosity range from about 200 to about 10,000 Pascal-seconds at 425° C. as measured by ASTM method D3835.

High performance polymer compositions that contain polyetherimides, which is a class of polyimides, are widely used in high temperature environments because polyetherimides possesses high heat resistance, excellent dimensional and thermal stability, chemical resistance and flame retardance. Polymer compositions containing polyetherimides are often used in electrical applications across a wide variety of industries such as the telecommunication and automotive industries, for example, because polyimide has excellent electrical properties, such as a high use temperature, a low dielectric constant, good flexibility and adhesion to metal.

Thin polymer films used in electronic applications, such as flex circuits, are often made from polyimides. Many polyimides that make high temperature films can only be processed from solution, usually as the polyamide acid. While this makes useful films the process requires chemical conversion of the polyamide acid to the polyimide, removal of solvent, and recovery of solvent. This makes the process more complex, more expensive, and environmentally less desirable. Other polyimides may be extruded into film using solventless processes such a melt extrusion. These melt processable polymers have a chemically distinct structure, wherein flexible linkages are built into the polymer backbone to enhance melt processability. Unfortunately such flexibilizing linkages very often lower the polyetherimide heat resistance, for example Tg, making such resin less acceptable for very high temperature applications. Very high heat capable polyimides, having only a single flexible linkage in the polymer backbone, are typically not processable by melting. A problem which exists with respect to polyimides is that in order to achieve good melt processability one loses heat capability, and to gain heat capability one loses melt processability. Some thermoplastic polyetherimides can have good melt processability, which allows them to be quickly and easily formed into articles by extrusion and molding processes. However, when such thermoplastic materials have relatively high glass transition temperatures (Tg), for example, around 270° C. or higher, they also have a relatively high melt viscosity which can limit its processability to yield commercial amounts of extruded film. Generally, high melt viscosity materials having a Tg greater than 270° C. will start to decompose and degrade if heated to temperatures needed to melt process them, for instance up to about 400° C. or higher.

Polyimides that have one or less flexible linkages in the repeat units of the polymer backbone may have a high glass transition temperature that can reach over 350° C., thereby providing exceptional temperature resistance. However such high temperature polyimides that have only one flexible link are, generally, not melt extrudable and many such polyimides can only be processed by using solution methods described above. Incorporation of flexible linkages can be used to make melt processable polyimides, however such flexibility can cause a loss of thermal stability, resistance to heat, and flammability.

Traditional solder process temperatures used in flex circuit fabrication require polymer films to possess a high glass transition temperature to withstand contact by molten solders. However, changes in the requirements of the electronics industry based on the required use of lead-free solder have further increased demands on the plastic substrate materials used in the manufacture of electronic circuits and devices. Elimination of lead from solder has raised the temperature at which the solder melts in some cases to 225° C. to 245° C. and films must remain stable when contacted by these solders having temperatures of at least 260° C. and in some instances upwards to about 290° C. or higher. Thus, the temperature of the molten solder has raised the glass transition requirements of polymer films used to make electronic devices that are contacted by molten solder during their manufacture or repair. Depending on the type of polymer used, these thin films can be easily melted or otherwise deformed by even short contact with molten solder. This is especially true of flexible circuits that are made on films as thin as 0.5 mils to 10 mils.

While film production via melt extrusion is a common industrial practice, melt processable materials which are substantially amorphous have not been able to achieve a Tg of greater than about 270° C. Thus there exists a need to make melt processable high temperature capable polymers that can be formed into films.

### SUMMARY

The present invention provides for polyetherimide film that has improved resistance to heat. In one embodiment the polyetherimide film has a glass transition temperature (Tg) that ranges from about 270° C. to about 350° C. and is made from a polyetherimide with a melt viscosity that ranges from about 200 Pascal-seconds (Pa-s) to about 10,000 Pascal-seconds at 425° C. as measured by ASTM method D3835. In another embodiment the polyetherimide film can resist deformation when contacted by molten solder having a temperature of at least about 260° C.

The present invention also provides for a multilayer structure having a film layer comprising a polyetherimide composition that has a melt viscosity that ranges from about 200 Pascal-seconds to about 10,000 Pascal-seconds at 425° C. as measured by ASTM method D3835 and having a glass transition temperature that ranges from about 270° C. to about 350° C. In another embodiment the film resists deformation when contacted with molten solder having a temperature of at least about 260° C.

### DETAILED DESCRIPTION

It has been found that films formed from polyetherimide resins comprising at least two flexible imide linkages are melt-processable and have improved heat resistance. The melt viscosity of the polyetherimide composition and the thermoplastic film, according to the various embodiments herein, can range from about 200 Pascal-seconds to about 10,000 Pascal-seconds at 425° C. as measured by ASTM method D3835. Other valuable characteristics such as solvent resistance, flexibility and electrical properties are also achieved. Furthermore, it is found that polyetherimide compositions and films derived from at least about 50 mole % oxydiphthalic anhydride, or chemical equivalent having a glass transition temperature (Tg) of at least about 270° C., can resist high temperature solder. In one instance a polyetherimide film comprising at least 50 mole % flexible linkages derived from oxydiphthalic anhydride (ODPA) can resist deformation, for example, melting, blistering, wrinkling, or other deformation, when in contact with molten solder having a temperature of at least 260° C. as described in IPC Method TM-650, number 2.4.13.

The polyetherimide resins according to an embodiment of the present invention comprise more than 1, typically from about 10 to about 1000 or more, and more preferably from about 30 to about 500 structural units of formula (I) 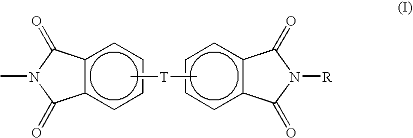
wherein T is —O— and R is independently selected from substituted and unsubstituted divalent aromatic radicals. The polyetherimide includes at least one R that contains a flexible linkage that allows for free rotation around the bonds of said linkage. Flexible linkages include, for example, aryl ether, aryl sulfide, or aryl sulfone.

In one embodiment R can contain at least two aromatic rings having a —O—, —S—, —SO₂— linkage or a group of the formula —O-Z-O— wherein the divalent bonds of the —O—, —S—, —SO₂— or the —O-Z-O— group are in the 3,3′, 3,4′, 4,3′, or the 4,4′ positions, and wherein Z includes, but is not limited, to divalent radicals of formula (II) 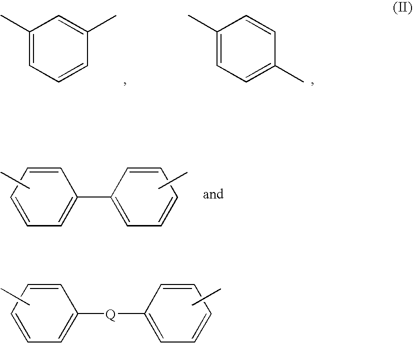
R in formula (I) includes but is not limited to substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (III)

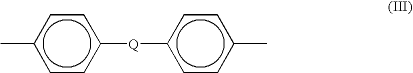

wherein Q includes but is not limited to a divalent moiety selected from the group consisting of —O—, —S—, —C(O)—, —SO₂—, C_{y}H_{2y}— (y being an integer from 1 to 5), and halogenated derivatives thereof, including perfluoroalkylene groups

The polyetherimides of the various embodiments of the present invention have at least 50 mole % imide linkages derived from aromatic bis (ether anhydride) that is an oxy diphthalic anhydride, in an alternative embodiment, from about 60 mole % to about 100 mole % oxy diphthalic anhydride derived imide linkages, in an alternative embodiment, from about 70 mole % to about 99 mole % oxy diphthalic anhydride derived imide linkages, and in yet another embodiment, from about 80 mole % to about 97 mole % oxy diphthalic anhydride derived imide linkages, and ranges there between, based on the moles of dianhydride present to form the polyetherimide.

The term “oxy diphthalic anhydride” means, for purposes of the embodiments of the present invention, the oxy diphthalic anhydride of the formula (IV) 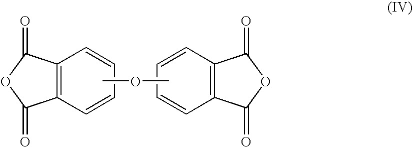
and derivatives thereof as further defined below.

The polyetherimides herein comprise structural units derived from reaction of the oxydiphthalic anhydrides with an organic diamine of the formula (V)
H₂N—R—NH₂ (V)
wherein R is defined as described above in formula (I). Melt processable polyimides of the invention, having a glass transition temperature (Tg) of at least about 270° C., may be made by reaction of more or less equal molar amounts of dianhydride, or chemical equivalent with a diamine containing a flexible linkage. In some cases the amount of dianhydride and diamine amine should differ by less than 5 mole %, this will help to give polymers of sufficient molecular weight to have useful mechanical properties such as stiffness, impact and resistance to tearing or cracking.

The oxy diphthalic anhydrides of formula (IV) includes 4,4′-oxybisphthalic anhydride, 3,4′-oxybisphthalic anhydride, 3,3′-oxybisphthalic anhydride, and any mixtures thereof. For example, the polyetherimide containing at least 50 mole % imide linkages derived from oxy diphthalic anhydride may be derived from 4,4′-oxybisphthalic anhydride structural units of formula (VI)

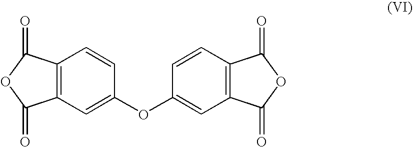

As mentioned above, derivatives of oxydiphthalic anhydrides may be employed to make polyetherimides. Examples of a derivatized anhydride group which can function as a chemical equivalent for the oxy diphthalic anhydride in imide forming reactions, includes oxydiphthalic anhydride derivatives of the formula (VII) 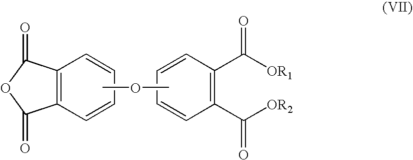
wherein R₁ and R₂ of formula VII can be any of the following: hydrogen; an alkyl group; an aryl group. R₁ and R₂ can be the same or different to produce an oxydiphthalic anhydride acid, an oxydiphthalic anhydride ester, and an oxydiphthalic anhydride acid ester.

The polyetherimides herein may include imide linkages derived from oxy diphthalic anhydride derivatives which have two derivatized anhydride groups, such as for example, where the oxy diphthalic anhydride derivative is of the formula (VIlI) 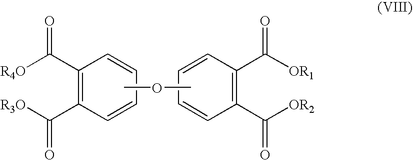
wherein R₁, R₂, R₃ and R₄ of formula (VIII) can be any of the following: hydrogen; an alkyl group, an aryl group. R₁, R₂, R₃, and R₄ can be the same or different to produce an oxy diphthalic acid, an oxy diphthalic ester, and an oxy diphthalic acid ester.

Copolymers of polyetherimides which include structural units derived from imidization reactions of mixtures of the oxy diphthalic anhydrides listed above having two, three, or more different dianhydrides, and a more or less equal molar amount of an organic diamine with a flexible linkage, are also within the scope of the invention. In addition, copolymers that have at least about 50 mole % imide linkages derived from oxy diphthalic anhydrides defined above, which includes derivatives thereof, and up to about 50 mole % of alternative dianhydrides distinct from oxy diphthalic anhydride are also contemplated. That is, in some instances it will be desirable to make copolymers that in addition to having at least about 50 mole % linkages derived from oxy diphthalic anhydride, will also include imide linkages derived from aromatic dianhydrides different than oxy diphthalic anhydrides such as, for example, bisphenol A dianhydride (BPADA), disulfone dianhydride, benzophenone dianhydride, bis(carbophenoxy phenyl)hexafluoro propane dianhydride, bisphenol dianhydride, pyromellitic dianhydride (PMDA), biphenyl dianhydride, sulfur dianhydride, sulfo dianhydride and mixtures thereof.

Therefore, of the homopolymers and copolymers described above, at least about 50 mole % of the imide linkages of the polyetherimide are derived from oxy diphthalic anhydride and at least 50 mole % of the imide linkages of the polyetherimide are derived from a second flexible linkage in addition to the flexible ether linkage of the oxy diphthalic anhydride, such that the glass transition temperature (Tg) of the polyetherimide is about 270° C. or higher and the melt viscosity can range from about 200 Pascal-seconds to about 10,000 Pascal-seconds at 425° C. as measured by ASTM method D3835.

In another embodiment polyetherimides which include structural units derived from imidization reactions of the dianhydrides and a more or less equal molar amounts of organic diamine as described above where the organic diamine includes an aryl diamine containing a flexible linkage. For example, a homopolymer which is the reaction product of 100 mole % oxy diphthalic anhydride and 100 mole % aryl diamine is within the scope of the invention. In addition, copolymers containing 100 mole % imide linkages derived from oxy diphthalic anhydride and two or more aryl diamines, or copolymers described above having imide linkages derived from two or more dianhydrides, including at least about 50 mole % oxy diphthalic anhydride, and at least one aryl diamine are also contemplated.

In another embodiment at least about 50 mole % of the imide linkages of the polyetherimide are sulfone linkages. In such case a portion of at least one of the aromatic dianhydride reactants and diamine reactants which forms the polyetherimide composition, includes a sulfone linkage. The oxy diphthalic dianhydride and organic diamine thereby react to form a polyetherimide composition that has two flexible linkages, namely a flexible ether linkage and a flexible sulfone linkage.

In another embodiment of the present invention, the oxy diphthalic anhydride, as defined above, reacts with an aryl diamine that has a sulfone linkage. In one embodiment the polyetherimide includes structural units that are derived from an aryl diamino sulfone of the formula (IX)
H₂N—Ar—SO₂—Ar—NH₂ (IX)

wherein Ar can be an aryl group species containing a single or multiple rings. Several aryl rings may be linked together, for example through ether linkages, sulfone linkages or more than one sulfone linkages. The aryl rings may also be fused.

In another embodiment the polyetherimide includes one or at least one aryl ether linkage derived from oxy diphthalic anhydride as defined above and one or at least one aryl sulfone linkage. The diamine employed in the synthesis of the polyetherimide composition can comprise at least about 50 mole % of aryl diamino sulfone, in an alternative embodiment, from about 50 mole % to about 100 mole % aryl diamino sulfone, in an alternative example embodiment, from about 70 mole % to about 100 mole % aryl diamino sulfone, and in yet another embodiment, from about 85 mole % to about 100 mole % aryl diamino sulfone, and ranges therebetween, based on the moles of aryl diamino sulfone to form the polyetherimide. In an example embodiment at least 50 mole % of the repeat units of the polyetherimide contains one aryl ether linkage and one aryl diamino sulfone linkage.

In alternative embodiments, the amine groups of the aryl diamino sulfone can be meta or para to the sulfone linkage, for example, as in formula (X)

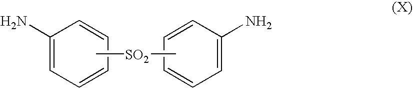

Aromatic diamines include, but are not limited to, for example, diamino diphenyl sulfone (DDS) and bis(aminophenoxy phenyl) sulfones (BAPS). The oxy diphthalic anhydrides described above may be used to form polyimide linkages by reaction with an aryl diamino sulfone to produce polyetherimide sulfones.

It has been found that melt viscosity of the polyetherimide having a Tg of at least about 270° C. and containing two flexible links or at least two flexible links as described above has a melt viscosity that allows the polyetherimide to be melt processed via melt extrusion while also having improved heat resistance. The melt viscosity of the polyetherimide can range from about 200 Pascal-seconds to about 10,000 Pascal-seconds at 425° C. as measured by ASTM method D3835.

As described above, polyetherimide homopolymers and copolymers with structural units derived from reactants comprising at least about 50 mole % of oxydiphthalic anhydride, as defined above, and aryl diamino sulfones are within the scope of the present invention. In one example embodiment a polyetherimide copolymer comprises aryl diamino sulfone and from about 50-85 mole % oxydiphthalic anhydride and from about 15-50 mole % of bisphenol A dianhydride or “BPADA”, based on the collective moles of dianhydride present. Oxydiphthalic anhydride/bisphenol A dianhydride (OPDA/BPADA) copolymers comprising additional aromatic dianhydrides and two or more aryl diamino sulfones are also contemplated. Copolymers that have two or more dianhydrides where at least about 50 mole % imide linkages are derived from oxy diphthalic anhydride and two or more diamines, provided that at least 50 mole % of the diamines have flexible linkages and the polyimide made from them is melt processable with a Tg of at least about 270° C. Copolymers may be made reacting a mixture of aryl diamines with oxydiphthalic anhydride. For instance a mixture of 4,4′-diamino diphenyl sulfone may be combined with 3,3,′-diamino diphenyl sulfone. In addition mixtures of several dianhydride and several diamines may be used in so far that at least 50 mole % of the imide linkage in the polymer are derived from oxy diphthalic anhydride and said imide linkages have at least one other flexible linkage. Examples of a second flexible linkage include, but are not limited to, ethers, sulfones and sulfides.

The polyetherimide of the various embodiments herein can be made by one of several known methods by one of ordinary skill in the art, including for example, the solvent precipitation method disclosed in U.S. Pat. No. 4,835,249 issued on May 30, 1989, and which is hereby incorporated by reference herein. For example, the reaction between the aromatic dianhydride and the organic diamine is initiated by heating the solution of the reactants in a high-boiling, above 110° C., aprotic organic solvent to a temperature sufficiently high to effect the reaction. A polyamide acid that is substantially insoluble in the aprotic solvent separates from the reaction solution as precipitate and the polyamide acid slurry is heated under imidization conditions while removing water of reaction. When the reaction is substantially complete the polyetherimide prepolymer is separated from the reaction solution, dried and subjected to melt polymerization by heating the polyetherimide prepolymer to a temperature that ranges from about 300° to about 450° C. in one of a variety of mixing equipment, for example, an extruder.

In another embodiment blends of polyetherimide polymers having two flexible linkages and a melt viscosity that ranges from about 200 Pascal-seconds to about 10,000 Pascal-seconds at 425° C. as measured by ASTM method D3835 can be made by combining oxy diphthalic anhydride derived polyetherimide with other polyimides that do not contain and oxy diphthalic anhydride derived linkage. For example, a homopolymer comprising imide linkages made by reaction of more or less equal a molar amounts of oxydiphthalic dianhydride reacted to form an imide with diamino diphenyl sulfone (DDS), can be combined with a homopolymer derived from bisphenol A dianhydride (BPADA) imidized by reaction with m-phenylene diamine (MPD). In another instance the oxy diphthalic anhydride (ODPA)/diphenyl sulfone (DDS) homopolymer can be combined with a homopolymer made from BPADA and DDS. In these blends sufficient polyimide containing ODPA derived linkages should be used to keep the blend Tg over 270° C. and the melt viscosity at 425° C. from 200-10000 Pa-s. In some cases the polyimide containing ODPA derived linkages will be at least 50 wt % of the blend. In other case it will be at least 70 wt % of the polyimide blend. Various blends of polyetherimide compositions were produced and tested in the examples provided below.

In some instances the polyetherimide polymer, which is subsequently converted into a film, should be free, or substantially free, of crystallinity. The presence of high melting crystals may give an intractable resin wherein the crystals cannot be melted without causing decomposition of the polymer. In this regard polymers that do not contain highly symmetric linkages, such as imide linkages derived from p-phenylene diamine (PPD), or pyromellitic dianhydride (PMDA) are preferred. In one embodiment the polyetherimide is substantially or essentially free of pyromellitic dianhydride which means that the polyetherimide has less than about 5 mole % of structural units, in some embodiments less than about 3 mole % structural units, and in other embodiments less than about 1 mole % structural units derived containing pyromellitic dianhydride. Free of pyromellitic dianhydride means that the polyimide film has zero mole % of structural units derived from monomers and end cappers containing pyromellitic dianhydride.

The key to making melt processable polyimides that have high heat capability is to combine diamine and dianhydride units to form polyimides that have flexibility in the polymer chain, but are not so flexible as to substantially lower the Tg. In addition the flexible linkages must be of a chemical nature that they to not decompose at high melt processing temperature (375-450° C.) or decompose by oxidative breakdown when the formed article is exposed to high end use temperatures. In addition the flexible linkages most be chosen such that it does not contribute to flammability. For instance the presence of aliphatic carbon hydrogen linkages, especially those where benzylic protons are present, while improving polymer backbone flexibility, can be detrimental to Tg, can detract from flame resistance and give poor melt stability. It has been found that the combination of flexible linkages derived from ether containing oxy diphthalic dianhydrides and diaryl diamine sulfones to give an excellent balance of high Tg, good melt viscosity and stability to make films that meet the needs of electronic applications, in view of the higher heat resistance needed to withstand molten solders which require higher melting temperatures, for example, lead-free solders.

Another aspect of the invention is a film made from polyetherimides such as polyetherimide sulfones with the stability needed for melt processing such that there is relatively little molecular weight change during the melting and part forming procedure. This requires that the polymer be free or substantially free of linkages that will react in the melt to change molecular weight. The presence of benzylic protons in polyetherimide typically accelerates reactions that change molecular weight in the melt. Due to the increased melt stability of the resultant polymer, polyetherimides with structural units derived from aromatic diamines, aromatic dianhydrides and capping agents essentially free of benzylic protons may be preferred in some applications, especially those involving isolation from the melt and melt processing after polymerization. In the present context substantially or essentially free of benzylic protons means that the polyimide sulfone product has less than about 5 mole % of structural units, in some embodiments less than about 3 mole % structural units, and in other embodiments less than about 1 mole % structural units derived containing benzylic protons. Free of benzylic protons means that the polyimide film has zero mole % of structural units derived from monomers and end cappers containing benzylic protons. The amount of benzylic protons can be determined by ordinary chemical analysis.

In another embodiment the polyetherimide is essentially free of halogen atoms. Essentially free of halogen atoms means that the polyetherimide has less than about 5 mole % of structural units, in some embodiments less than about 3 mole % structural units, and in other embodiments less than about 1 mole % structural units derived containing halogen atoms. The amount of halogen atoms can be determined by ordinary chemical analysis.

Low levels of residual volatile species, such as solvent, in the final polymer product are achieved by known methods, for example, by devolatilization or distillation. Suitable devolatilization apparatuses include, but are not limited to, wiped films evaporators, and devolatilizing extruders, especially twin screw extruders with multiple venting sections. Multiple devolatilization steps may be employed, for example two wiped film evaporators used in series, or a devolatilizing extruder used in a serial combination with a wiped film evaporator.

Polyetherimides of the present invention, particularly those made in a solvent process, have low levels of residual volatile species. For example chlorobenzene, dichlorobenzene, xylene, toluene, anisole, diphenyl ether, diphenyl sulfone, dimethyl formamide, dimethyl acetamide, N-methyl pyrrolidone or mixtures thereof. In example embodiments, the polyimide sulfone has a residual volatile species concentration of less than about 500 ppm, in other instances less than about 300 ppm, in alternative embodiments less than about 200 ppm, and in yet alternative embodiments less than about 100 ppm. Higher levels of solvent may in some cases make melt processing of the film difficult due to foaming. Residual solvent may also detract from electrical properties or lead to possible corrosion of attached metal surfaces or components.

A chain-terminating agent may be employed to control the molecular weight of the final polymer product. Mono-functional amines such as aniline, or mono-functional anhydrides such as phthalic anhydride may be employed. Generally, the polyetherimides herein have a melt index of about 0.1 to about 10 grams per minute (g/min), as measured by American Society for Testing Materials (ASTM) D1238. The polyetherimide resin of the above embodiments can have a weight average molecular weight (Mw) of about 5,000 to about 100,000 grams per mole (g/mole), in some embodiments a Mw of about 10,000 g/mole to about 50,000 g/mole, and in alternative embodiments, a Mw of about 15,000 g/mole to about 40,000 g/mole as measured by gel permeation chromatography, using a polystyrene standard. Such polyetherimide resins typically have an intrinsic viscosity greater than about 0.2 deciliters per gram (dl/g), preferably about 0.35 to about 0.7 dl/g measured in m-cresol at 25° C.

A measure of melt processability necessary to make thin films having a thickness of about 1 to about 100 microns is to show a melt viscosity of less than about 50,000 Pascal-seconds at a temperature where the polymer does not fume or crosslink, thereby remaining a thermoplastic. The compositions of example embodiments have a melt viscosity that can range from about 200 to about 10,000 Pa-s, in some embodiments from about 500 to about 8,000 Pa-s, and in alternative embodiments from about 2,000 to about 5,000 Pa-s at temperatures of greater than or equal to 425° C. as measured by capillary rheometry as per ASTM method D3835.

In addition it is sometimes useful in melt processing to have resins that show shear thinning, in which the viscosity of the molten resin decreases at higher shear rates. The viscosity ratio at a high shear rate, for example 1000 sec-1, to a lower shear rate, for example 100 cm-1, can yield a viscosity ratio that is indicative of shear thinning behavior. It is desirable to have such a low shear rate to high shear rate viscosity ratio of at least about 1.7, in alternative embodiments greater than about 2.0, and in alternative embodiments greater than about 2.5. A low shear rate can be, for example, 90-140 l/sec. A high shear rate can be, for example, from 800-1100 l/sec.

The glass transition temperatures of polyetherimide resins suitable for solder resistant films, for example, must be from about 270 to 350° C. as measured by DSC, for example as according to ASTM method D3418. With a Tg too low the polyetherimde will not withstand the solder heat, if the Tg is too high it will not be capable of melt processing without degradation or other issues.

Polyimide films with good dimensional stability are desirable for applications such as electronic circuits. One aspect of dimensional stability is the coefficient of thermal expansion (CTE). CTE may be measured on films as described in ASTM E831. In general the CTE can vary from about 30 to about 60 um/m ° C., and in some instances, it may be from about 30 to about 50 um/m ° C. (ppm/° C.) where the temperature range used for the mean coefficient of thermal expansion is 20° to 70° C.

Having a polyimide film that is free of ionic impurities can be desirable in demanding electronic applications. Cations from the alkaline and alkaline earth family can be especially troublesome. Polyetherimde films that contain less than 100 ppm of these cations are preferred for many applications. In other instances the alkaline or alkaline earth cations should be below 50 ppm. Ion concentration can be measured by many techniques known in the art, for instance ion chromatography or plasma emission spectroscopy.

The film of the present invention can be made by extruding the polymer compositions in the embodiments described above using, for example, a single or a twin screw extruder. The polymer composition, for example in powder, pellet or another suitable form can be melted at temperatures effective to render the polyetherimide molten and extruding into a film, for example, at a temperature range from about 380° C. to about 450° C. The polyetherimide compositions herein can be extruded into a film having various thicknesses that can range, for example, a film thickness of about 20 mils or less, in other embodiments ranges from about 10 mils to about 5 mils, and in alternative embodiments ranges from about 0.5 mils to about 50 mils

The films produced herein can be used for several applications, including substrates for many electrical and electronic applications. For example, films made from the polyetherimide compositions of the embodiments described herein can be used for substrates of flexible circuits. These applications require that they withstand contact by molten solder during manufacture and assembly. Elimination of lead from solder has raised the temperature at which the solder melts to a minimum of 260° C. and up to about 300° C. Films made from the polyetherimide compositions of the present invention can resist deformation by contact with molten solder, including lead-free solder, even films which are as thin as 0.5 mils to 10 mils

Other applications for the polyetherimide compositions and films containing these polyetherimide compositions according to the various embodiments described herein include but are not limited to, insulation, for example cable insulation and wire wrapping; construction of motors; electronic circuits, for example flexible printed circuits; transformers; capacitors; coils; switches; separation membranes; computers; electronic and communication devices; telephones; headphones; speakers; recording and play back devices; lighting devices; printers; compressors; and the like.

Optionally, the film can be metallized or partially metallized, as well as coated with other types of coatings designed to enhance physical, mechanical, and aesthetic properties, for example, to improve scratch resistance, surface lubricity, aesthetics, brand identification, structural integrity, and the like. For example, the films can be coated with printing inks, adhesives, conductive inks, and similar other materials. Metallization processes include, for example, lamination, sputtering, metal vapor deposition, ion plating, arc vapor deposition, electroless plating, vacuum deposition, electroplating, and other methods. Non limiting examples of useful metals are copper, gold, silver, aluminum, chrome, nickel, zinc, tin, and mixtures thereof

The polymer, copolymer and blend compositions according to example embodiments of the present invention, can also be combined with other optional ingredients such as mineral fillers, for example, talc, clay, mica, barite, wollastonite, silica, milled glass and glass flake; colorants, for example, titanium dioxide, zinc sulfide, and carbon black; lubricants; flame retardants; and ultra violet light stabilizers, for example. The compositions can also be modified with effective amounts of inorganic fillers, such as, for example, carbon fibers and nanotubes, metal fibers, metal powders, conductive carbon, and other additives.

The present invention is further illustrated by the following non-limiting examples. Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

### Examples 1-6

Various polyetherimide compositions containing imide linkages derived from oxydiphthalic anhydride (OPDA) and diamino diphenyl sulfone (DDS) were made into film samples by melt extrusion. The glass transition temperatures of the film samples were measured and the film samples were also tested for their resistance to molten lead-free solder. These film samples 1-6 were compared to films made from a polyetherimide homopolymer containing imide linkages derived from bisphenol A dianhydride (BPADA) and m-phenylene diamine (MPD) (example Control 1) and a polyetherimide sulfone homopolymer containing imide linkages derived from bisphenol A dianhydride (BPADA) and diamino diphenyl sulfone (DDS) (example Control 2). The results are listed in Table 1 below.

Film samples used in Examples 1, 2, 3, Control 1, and Control 2 were made by polymerizing substantially equal molar amounts of dianhydride relative to diamine according to well known polymerization processes to produce homopolymers and copolymers of various compositions containing varying amounts of oxydiphthalic anhydride (OPDA), bisphenol A dianhydride (BPADA), diamino diphenyl sulfone (DDS), and m-phenylene diamine (MPD) as indicated in Table 1. Film samples used in examples 4, 5, and 6 were made using blends of the two distinct polyetherimides homopolymers used in Example Control 2 (100% BPADA/100% DDS) and Example 3 (100% OPDA/100% DDS) by varying the amounts of homopolymers to produce blend polyetherimides having the compositions indicated in Table 2.

In preparation of film samples used in examples 1, 2, 3, and examples Control 1 and Control 2, the homopolymers and copolymers were pelletized by extrusion. The resultant polymer resins had a Mw that ranged from between 20,000 to 30,000. The pellets for examples 1 and 2 were ground into 325 mesh powder and dried at approximately 200° C. for at least four hours prior to extrusion. The powder was fed at a feed rate of 0.3 to 0.5 Kg/hr through a PRISM brand TSE16 mm twin screw extruder (LUD=25) and a 152 mm (6 inch) die. The co-rotating and intermeshing screw extruder rotated at 100 to 300 RPM at a barrel set point temperature that ranged between approximately 380° C. to 420° C. The actual melt temperature of the polymers ranged between about 380 ° C. and about 425 ° C. The pellets for example 3 were dried for 12 hours at 200 C and fed at a rate of about 2.3 Kg/hr into a 32 mm single screw extruder that was run at 25 RPM at a barrel temperature that ranged between 376° C. to 406° C. and through a 152.4 mm (6 inch) die. The actual melt temperature of the polymers ranged between about 380° C. and about 410 ° C.

The polymer blends used to make the film samples used in examples 4, 5, and 6 were made by grounding the homopolymer compositions into powder form and mixing the powders in various ratios as shown in Table 2. The blends for examples 4 and 5 were compounded in an extruder to make pellets. The pellets were then ground into powders, then dried at 200° C. for about 10 hours. The powder was fed at a feed rate of 0.5 to 2 Kg/hr through a PRISM brand TSE16 mm twin screw extruder (L/D=25) and a 152.4 mm (6 inch) die. The co-rotating and intermeshing screw extruder rotated at 100 to 300 RPM at a barrel set point temperature that ranged between approximately 380° C. to 400° C. The actual melt temperature of the polymers ranged between about 380° C. and about 410° C. The pellets for example 6, and examples Control 1 and Control 2 were dried for 12 hours at 180 C in a desiccant drier fed at a rate of about 4.5 Kg/hr into a 38 mm single screw extruder that was run at 20 RPM at a barrel temperature that ranged between 393° C. to 404° C. and through a 40 cm die. The film extrusion operations of homopolymers, copolymers, and blends described above produced films that ranged from about 0.025 millimeter (1.0 mil) to about 0.25. millimeter (10 mil) thickness. The glass transition temperatures of the film samples were measured by differential scanning calorimetry according to ASTM method D3418. The film samples were also tested for their resistance to molten lead free solder as per IPC method TM-650; 2.4.13 rev. F. The polyetherimide films were conditioned in an air circulating oven at 135° C. for one hour. The films were then contacted by molten solder as per the test at 260° C. (method A) for 10 seconds and evaluated. Films failed the test if melting, blistering, distortion, or shrinkage was observed. At least two specimens were tested at each temperature.

TABLE 1
Homopolymers and copolymers

| | Control 1 | Control 2 | Ex. 1 | Ex. 2 | Ex. 3 |
|---|---|---|---|---|---|
| OPDA mole % | 0 | 0 | 65 | 80 | 100 |
| BPADA mole % | 100 | 100 | 35 | 20 | 0 |
| DDS mole % | 0 | 100 | 100 | 100 | 100 |
| MPD mole % | 100 | 0 | 0 | 0 | 0 |
| Tg ° C. | 217 | 249 | 280 | 295 | 310 |
| Solder Float | Failed | Failed | Pass | Pass | Pass |
| 260° C. | (melted) | (distorted) | | | |
| CTE ppm ° C. | 56 | 51 | 43 | 42 | 46 |

TABLE 2
Blends of OPDA/DDS and BPADA/DDS Homopolymers

| | Ex. 4 | Ex. 5 | Ex. 6 |
|---|---|---|---|
| OPDA-DDS PEI wt % | 60 | 75 | 85 |
| BPADA-DDS PEI wt % | 40 | 25 | 15 |
| Tg ° C. | 274 | 284 | 290 |
| Solder Float 260° C. | Pass | Pass | Pass |
| CTE ppm ° C. | | 46 | 49 |

The results of Tables 1 and 2 show that all polymers having at least 60% imide linkages derived from OPDA containing resins of examples 1 through 6 passed the solder float test at 260° C. Control sample 1 that contained bisphenol A dianhydride (BPADA) but no oxydiphthalic anhydride (ODPA) derived linkages had a substantially lower glass transition temperature and failed the solder float test. Control sample 2 which contained bisphenol A dianhydride (BPADA) derived linkages but did not contain any aryl sulfone linkages had an even lower glass transition temperature and failed the solder test. In all film samples used in the testing of examples 1-6 the films underwent a film flex test prior to testing the glass transition temperature and the solder float. In the flex test each film sample was folded over itself such that substantially all of the film is in contact with another portion of the same film. All of the film samples passed the film flex test and did not break.

The coefficient of thermal expansion was measured on the films of examples 1,2,3,5 and 6 as per ASTM method E83 1, CTE values ranged from 40-49 ppm ° C. In this case CTE values were reduced compared to control examples 1 and 2.

### Examples 7-15

The melt processability of various polyetherimide homopolymers, copolymers, and blends were tested by determining the melt viscosity at a series of shear rates, the results of which are shown in Tables 3 and 4 below. In Examples 7-10 copolymers containing 65 mole % linkages derived from oxydiphthalic anhydride (OPDA) and 35 mole % bisphenol A dianhydride (BPADA) and 100 mole % diamino diphenyl sulfone (DDS) of varying weight average molecular weights, Mw of 23,000 and 28,000 were tested for melt viscosity at 412° C., 430° C., and 450° C., respectively. In Example 11 copolymer containing 80 mole % linkages derived from oxydiphthalic anhydride (OPDA) and 20 mole % bisphenol A dianhydride (BPADA) and 100 mole % diamino diphenyl sulfone (DDS) at Mw of 23,000 was tested for melt viscosity at 412° C. In examples 12-15 blends containing 75 and 85 wt % polymer derived from oxydiphthalic anhydride (OPDA) imidized with DDS (100 mole % ODPA and DDS) and 25 and 15 wt % of a polyimide derived from bisphenol A dianhydride (BPADA) and diamino diphenyl sulfone (100 mole % BPADA and DDS) were tested for melt viscosity at 430° C., and 450° C.

The polyetherimide homopolymer, copolymers, and blend pellets were dried at 200° C. for at least four hours and tested on a capillary rheometer using a 1.0 mm diameter by 10.0 mm die as described in ASTM method D3835.

TABLE 3
Melt Viscosity vs. Shear Rate for Homopolymers and Copolymers

| | Ex. 7 | Ex. 8 | Ex. 9 | Ex. 10 | Ex. 11 |
|---|---|---|---|---|---|
| OPDA | 65 | 65 | 65 | 65 | 80 |
| mole % | | | | | |
| BPADA | 35 | 35 | 35 | 35 | 20 |
| mole % | | | | | |
| DDS | 100 | 100 | 100 | 100 | 100 |
| mole % | | | | | |
| Mw | 23,000 | 28,000 | 28,000 | 28,000 | 23,000 |
| Temp | 412 | 412 | 430 | 450 | 412 |
| ° C. | | | | | |
| Shear | Viscosity (Pascal-seconds, Pa-s) | | | | |
| Rate | | | | | |
| (1/sec) | | | | | |
| 6000 | | | 594 | 323 | |
| 5886 | 334 | 314 | | | 421 |
| 3454 | 478 | 425 | | | 567 |
| 3183 | | | 963 | 516 | |
| 2286 | 657 | 570 | | | 743 |
| 1689 | | | 1483 | 724 | |
| 1520 | 877 | 683 | | | 991 |
| 997 | 1115 | 888 | | | 1258 |
| 896 | | | 2185 | 886 | |
| 645 | 1400 | 1116 | | | 1629 |
| 476 | | | 2952 | 1066 | |
| 438 | 1726 | 1364 | | | 2025 |
| 292 | 2370 | 1610 | | | 2484 |
| 252 | | | 3703 | 1249 | |
| 195 | 2379 | 1816 | | | 2859 |
| 134 | | | 4614 | 1514 | |
| 122 | 2980 | 2232 | | | 3554 |
| 85 | 3419 | 2402 | | | 3998 |
| 71 | | | 5626 | 1847 | |
| 61 | 3943 | 2849 | | | 4421 |
| 38 | | | 7041 | 2268 | |
| 37 | 4894 | 3520 | | | 5169 |
| 24 | 5897 | 4113 | | | 5763 |
| 20 | | | 8751 | 3161 | |
| Shear | 2.67 | 2.51 | 2.11 | 1.71 | 2.83 |
| thinning | | | | | |
| viscosity | | | | | |
| ratio at | | | | | |
| 122/997 or | | | | | |
| 134/896 | | | | | |
| (1/sec.) | | | | | |

TABLE 4
Melt Viscosity vs. Shear Rate for Homopolymer Blends

| | Ex. 12 | Ex. 13 | Ex. 14 | Ex. 15 |
|---|---|---|---|---|
| OPDA-DDS PEI wt % | 75 | 75 | 85 | 85 |
| BPADA-DDS PEI wt. % | 25 | 25 | 15 | 15 |
| Temp ° C. | 430 | 450 | 430 | 450 |
| Shear Rate (1/sec) | Viscosity (Pascal-seconds, Pa-s) | | | |
| 6000 | 533 | 408 | 830 | 408 |
| 3183 | 864 | 654 | 1267 | 654 |
| 1689 | 1322 | 942 | 1783 | 942 |
| 896 | 1888 | 1240 | 2517 | 1240 |
| 476 | 2491 | 1556 | 3300 | 1556 |
| 252 | 3057 | 1867 | 3942 | 1867 |
| 134 | 3718 | 2326 | 4664 | 2326 |
| 71 | 4565 | 2939 | 5501 | 2854 |
| 38 | 5601 | 3690 | 6399 | 3334 |
| 20 | 6828 | 4892 | 7640 | 4241 |
| Shear thinning viscosity | 1.97 | 1.88 | 1.85 | 1.88 |
| ratio at 134/896 (1/sec.) | | | | |

The results show that in all cases that the polyetherimide resins containing oxydiphthalic anhydride (ODPA) and DDS derived imide linkages showed good melt flow at 412-450° C. In Examples 7-11 (Table 3) polyetherimide sulfone copolymers show melt flows of under 10,000 Pa-s at 412 to 450° C. Examples 12-15 in Table 4 show blends of 75-85 wt % of a polyetherimide sulfone homopolymer containing essentially all ODPA and DDS derived linkages with 15-25 wt % of a BPADA-DDS derived polyimide with no ODPA linkages. Examples 12-15 also show melt flow below 10000 Pa-s. In addition Examples 11-15 all show shear thinning behavior as can be seen by comparing the ratio of the melt viscosity at a low shear rate near 100 l/sec (in this instance shear rates of 122 or 134 l/sec are used) to the viscosity at a shear rate near 1000 l/sec (in this case 997 or 896 l/sec). In all examples the ratio of the low shear rate to the high shear rate is greater than about 1.7.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

We claim:

1. A film comprising:
a polyetherimide polymer having a glass transition temperature that ranges from about 270° C. to about 350° C.; and
wherein the melt viscosity of the polyetherimide ranges from about 200 to about 10,000 Pascal-seconds at 425° C. as measured by ASTM method D3835.

2. The film of claim 1, wherein the polyetherimide polymer has at least two flexible linkages.

3. The film of claim 2, wherein the flexible linkages comprise one ether linkage and one sulfone linkage.

4. The film of claim 1, which when contacted by molten solder having a temperature of at least 260° C., resists deformation as per IPC method TM-650.

5. The film of claim 1, wherein the ratio of the melt viscosity at a shear rate of 100 sec-1 to the melt viscosity at a shear rate of 1,000 sec-1 is at least about 1.7.

6. The film of claim 1, wherein at least about 50 mole % of the imide linkages are derived from the group of oxydiphthalic anhydrides, oxydiphthalic acids, oxydiphthalic esters, and combinations thereof.

7. The film of claim 6, wherein the polyetherimide film comprises imide linkages derived from diamino aryl sulfone.

8. The film of claim 7, wherein:
at least about 60 mole % of the imide linkages are derived from the group of oxydiphthalic anhydrides, oxydiphthalic acids, oxydiphthalic esters, and combinations thereof; and
up to about 40 mole % of the imide linkages are derived from bisphenol A dianhydride.

9. The film of claim 8, wherein about 100 mole % of the imide linkages are derived from diamino diphenyl sulfone.

10. The film of claim 1, wherein at least about 50 mole % of the imide linkages are derived from diamino diaryl sulfones.

11. The film of claim 10, wherein the polyetherimide comprises imide linkages derived from at least one of diamino diphenyl sulfone and bis(aminophenoxy phenyl)sulfone.

12. The film of claim 1, wherein the polyetherimide comprises at least about 50 mole % imide linkages derived from oxydiphthalic anhydrides and at least about 25 mole % imide linkages derived from diaryl diamino sulfone.

13. The film of claim 1, wherein the film comprises a blend of a first polyetherimide polymer and a second polyetherimide polymer which are distinct from one another; and
wherein the first polyetherimide polymer comprises at least about 50 mole % oxydiphthalic anhydride derived linkages and the second polyetherimide is essentially free of oxydiphthalic anhydride derived linkages.

14. The film of claim 13, wherein at least about 50% by weight of the blend comprises polyetherimide polymer containing oxydiphthalic anhydride derived linkages.

15. The film of claim 1, wherein the film is substantially free of crystallinity as determined by differential scanning calorimetry per ASTM method D3418.

16. The film of claim 1, wherein the polyetherimide is essentially free of linkages derived from pyromellitic dianhydride.

17. The film of claim 1, wherein the polyetherimide is essentially free of benzylic protons.

18. The film of claim 1, wherein the polyetherimide is essentially free of halogen atoms.

19. The film of claim 1, wherein the thickness of the film ranges from about 1 to about 1000 microns.

20. The film of claim 1, wherein the film is made by melt extrusion processing.

21. The film of claim 1, wherein the film has less than about 500 ppm residual solvent.

22. The film of claim 1, wherein the polyetherimide film has less than about 100 ppm of alkaline or alkaline earth metal cations.

23. The film of claim 1, wherein the film has a coefficient of thermal expansion that ranges from about 20 ppm/° C. to about 60 ppm/° C. as measured by ASTM method E-831.

24. A film comprising:
polyetherimide wherein substantially all imide linkages comprise at least one oxydiphthalic anhydride derived ether group and at least one sulfone group;
wherein the polyetherimide has a glass transition temperature that ranges from about 270° C. to about 350° C.;
wherein the melt viscosity of the polyetherimide ranges from about 500 to about 8,000 Pascal-seconds at 425° C. as measured by ASTM method D3835; and
wherein the film when contacted by molten solder having a temperature that ranges from about 260° C. to about 300° C., resists deformation as per IPC method TM-650.

25. A film comprising:
polyetherimide polymer wherein substantially all imide linkages of the polyetherimide polymer comprise at least one oxydiphthalic anhydride derived ether group and at least one sulfone group;
wherein the polyetherimide has a glass transition temperature that ranges from about 270° C. to about 350° C.;
wherein the melt viscosity of the polyetherimide ranges from about 500 to about 8,000 Pascal-seconds at 425° C. as measured by ASTM method D3835;
wherein the film when contacted by molten solder having a temperature that ranges from about 260° C. to about 300° C., resists deformation as per IPC method TM-650; and
wherein the film is substantially free of crystallinity as determined by differential scanning calorimetry per ASTM method D3418.

26. A multilayer structure wherein at least one layer comprises a polyetherimide film wherein substantially all imide linkages of the polyetherimide polymer comprise at least one ether group and at least one sulfone group;
that resists deformation when contacted by solder having a temperature of at least 260° C. as per IPC method TM-650.

27. The multilayer structure of claim 26, wherein the polyetherimide film has a glass transition temperature that ranges from about 270° C. to about 350° C.

28. The multilayer structure of claim 27, wherein the polyetherimide film is essentially free of crystallinity as determined by differential scanning calorimetry as per ASTM D3418.

29. The multilayer structure of claim 27, wherein the polyetherimide film has a coefficient of thermal expansion that ranges from about 30 ppm/° C. to about 60 ppm/° C. as measured by ASTM method E831.

30. The multilayer structure of claim 27, wherein the polyetherimide film has a melt viscosity that ranges from about 200 Pascal seconds to about 10,000 Pascal seconds at 425° C. as measured by ASTM method D3835.

31. The multilayer structure of claim 27, wherein the at least one layer comprises metal.

32. The multilayer structure of claim 31, wherein the metal is selected from the group consisting of: copper, gold, silver, aluminum, chrome, nickel, zinc, tin, and mixtures thereof.

33. A film comprising:
A blend of at least two polyetherimides wherein greater than or equal to 50 wt % of the blend composition is a polyetherimide where substantially all imide linkages comprise at least one oxydiphthalic anhydride derived ether group and at least one sulfone group and
50 wt % or less of a second polyetherimide that does not contain an oxydiphthalic anhydride derived imide linkage;
wherein the oxydiphthalic anhydride derived polyetherimide has a glass transition temperature that ranges from about 270° C. to about 350° C.;
wherein the melt viscosity of the polyetherimide blend ranges from about 500 to about 8,000 Pascal-seconds at 425° C. as measured by ASTM method D3835; and
wherein the film when contacted by molten solder having a temperature that ranges from about 260° C. to about 300° C., resists deformation as per IPC method TM-650.
